(19) United States
(12) Patent Application Publication
(10) Pub. No.: US 2006/0290815 A1
(43) Pub. Date: Dec. 28, 2006

(54) Video signal displaying system

(76) Inventors: Yi-Chih Chang, Hsin Chu (TW); Wen-Ming Lu, Hsin Chu (TW)

Correspondence Address: Hung Chang LIN, 8 Schindler Ct., Silver Spring, MD, 20903, US

(21) Appl. No.: 11/225,716

(22) Filed: Sep. 14, 2005

(30) Foreign Application Priority Data
Jun. 28, 2005 (TW) 094122009

(51) Int. Cl. H04N 5/46; H04N 9/74

(52) U.S. Cl. 348/558; 348/581

(57) ABSTRACT

An analog color video signal is inputted to a chip, which converts the analog signal into digital video signal. The digital color difference signals are then converted into three primary color format. Then a format detector detects the resolution and the scanning format. If the video signal is of interlaced scanning format, the detector unit removes the interlacing and converts the interlace into progressive format. The video signal is enhanced by a enhancing unit and adjusted to fit into the frame of the display screen.

### BACKGROUND OF THE INVENTION

1. Field of the Invention

This invention relates to video signal displaying system, in particular to a system-on-chip for processing the analogy coloe difference singals to display on the liquid crystal display.

2. Brief Description of Related Art

When analog composite signal is used for video display input, the display can only have low resolution for an interlaced 480 line signal. In U.S. Pat. No. 6,356,277, the composite signal is converted into digital signal, and is decoded by an analog-to-digital converter into luminance (Y) and chrominance (C) signals. The C signal is further converted into U and V signals to measure the difference in color. The YUV signals are then converted into three primary colors: red, green and blue (RGB). Then the image controller performs interlaced scanning. Finally, the liquid crystal display controller processes the RGB signals for display on the screen.

If high quality of the image, the color difference signal contains a luminance signal Y and two chrominance signals U and V, or a B-Y and a R-Y signal. Customarily, Y, Cb, Cr are the digital color difference signals; Y, Pb, Pr are the analog color difference signals . When the composite signal is to be segregated into Y, U, V signals, the segregation tends to cause distortion . Therefore, when the composite signal is transmitted and then processed, high quality image cannot be obtained. If the color difference signals are processed, the distortion problem need not considered and higher quality picture can be obtained.

U.S. Pat. No. 6,177,946 disclosed a digital signal processing method for a personal computer (PC). The digital color difference signal YCbCr is first processed through a scale circuit to enlarge or reduce to fit the screen dimension, and then processed through a format converter to convert into RGB format.

U.S. Pat. No. 6,518,970 disclosed another processing method for a PC. The digital color difference signal in the frame buffer is first converted into RGB format and then blended with graphic signal in a blender. The blended signal is then processed through a color coordinate converter, signal scaler and offset generator to combine with a sync signal generator to produce a synchronized signal.

Taiwan Patent No. 1222331 disclosed still another method. The received color difference signal is segregated by a segregation circuit into synchronized horizontal signal and synchronized vertical signals. If the input signal is a 480i interlaced signal or a 576i interlaced signal, an input microprocessor controls the bus to decode the input signal into digital video signals, multiplies the frequency to remove the interlace, and then amplifies with a chip for display on a display unit. If the input is a progressive 480p, 576p, 720p or interlaced 1080i signal , a microprocessor controls the sequence, converts the input analog signal into digital signal, segregates the color difference signals into digital video signals, converts the chroma signals into RGB formats, and displays the signals on a screen. In other words, one method is to decode the input signals into digital signals and then to remove the interlacing signal. Alternatively, the analog signal is converted into digital signal, and then converted into chroma signals.

### SUMMARY OF THE INVENTION

An object of the present invention is to provide a high resolution video display on a liquid crystal screen. The analogy color difference signals are used for video signal input. After processing though the present invention, a high resolution video signals will be displayed on the liquid crystal display.

Another object of the present invention is to reduce the cost in processing video signals. The preent invention provides a system-on-chip integrated entire system in order to effecively reduce the manufacture cost.

Still another object of the present invention is to reduce the complexity in the design of liquid crystal display.

These objects are achieved by using an analog color difference signal as input, and then processed for display on a high resolution liquid crystal display. A single chip is used to process an analog color difference signal. The analog color difference signal (Y,Pb,Pr) is converted into digital color difference signal (YUV) by an analog-to-digital converter unit. The converted digital color difference signal is further converted by a chromaticity coordinate converter into RGB format. Then a format detector determines the video signal resolution and the scanning format. If the scanning format is of interlacing format, the interlacing format is changed to progressive scanning format. Alternatively, the digital color difference signal may also be first detected as to video signal resolution and scanning format. If the scanning format is of interlacing type, the interlacing format is deinterlaced to become progressive format. The signal is then converted into RGB format. The video signal is further processed to enhance the picture quality and adjusted to fit a liquid crystal display frame.

### BRIEF DESCRIPTION OF THE DRAWINGS

FIG. 1 shows a first embodiment of the present invention;

FIG. 1a shows a first version of the first embodiment according to the present invention;

FIG. 1b shows a second version of the first embodiment according to the present invention.

FIG. 2 shows a second embodiment of the present invention;

FIG. 2a shows a first version of the second embodiment according to the present invention; and

FIG. 2b shows a second version of the second embodiment according to the present invention.

### DETAILED DESCRIPTION OF THE INVENTION

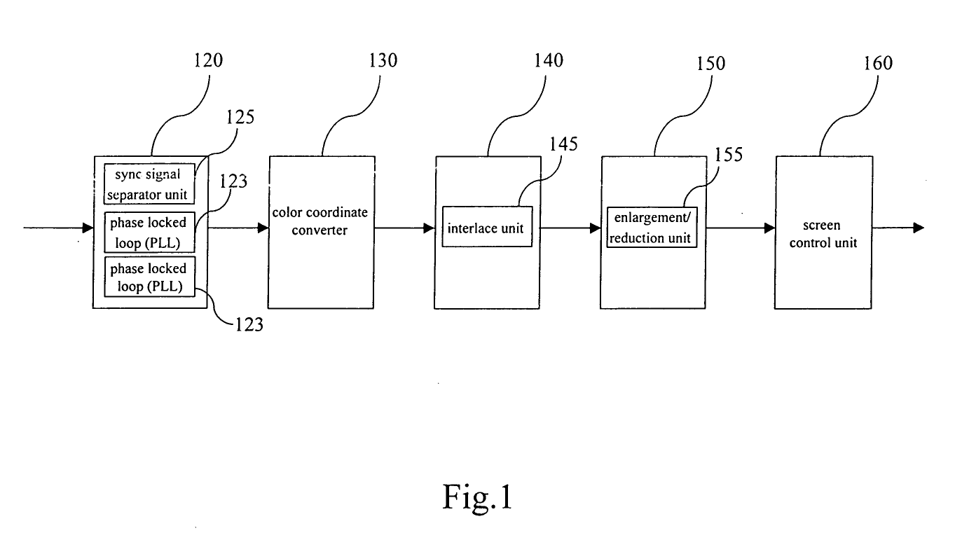

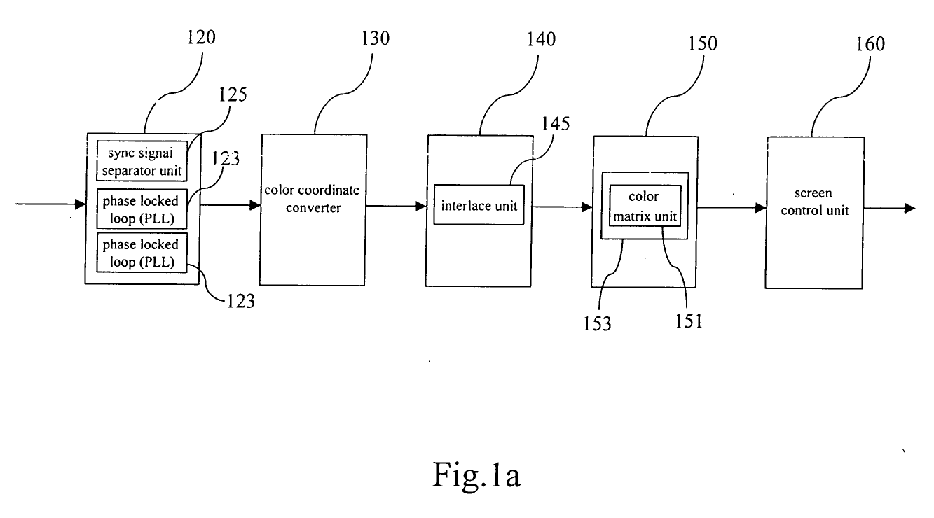

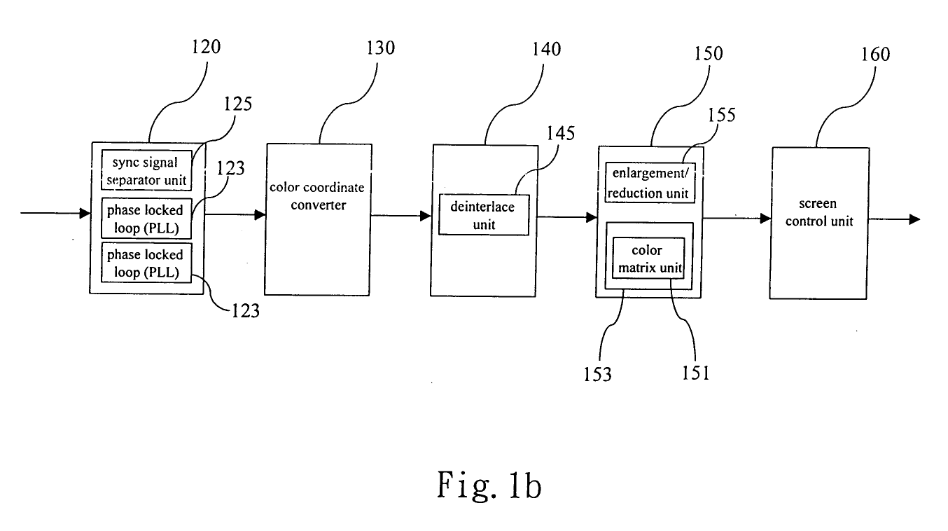

FIG. 1 shows a first preferred embodiment of the present invention. First, an analog chroma difference format is inputted to an analog-to-digital converter (ADC) chip 120 to convert the analog number into digital color difference format. The analog converter unit 120 contains a sync signal separator unit 125 to separate out horizontal sync signal and the vertical sync signal in the luminance signal Y. In addition, the ADC unit 120 also contains two phase locked loops (PLL) 123 to produce a source timing clock and panel timing clock to supply different timing needs in different units in the present system.

The digital color difference digital signal is followed by a color coordinate converter 130 for conversion into three primary color RGB format. The a format detector unit 140 determines the display format, including resolution and scanning format, such as 480 i/p, 576p, 720p and 1080i/p formats, but not limited to these formats. If it is determined that the scanning format is of interlace type, the interlace unit 145 in the detector unit 140 converts the interlace format into progressive format. Basically, all the signals from the detector unit 140 are of progressive type.

The progressive format signal from the detector unit 140 is processed by a video processing unit 150. This video processing unit 150 includes an enlargement/reduction unit 155, which adjusts the video signal according to the signal resolution and the screen solution.. Finally, the screen control unit 160 outputs the adjusted signal on a screen.

Another version of the first embodiment is shown in FIG. 1a. The video processing unit 150 includes a video enhancement unit 153, which processes the video signals to enhance the quality such as gray color and black and white stretch, white balance and white tone enhancement, color transition improvement, and skin tone enhancemen, etc. The video enhancement unit 153 also contains a color matrix unit 151 for color saturation and hue processing, etc. Finally, the signal is transmitted through a screen control unit 160 to display the image on a liquid crystal frame.

In a second version of the first embodiment as shown in FIG. 1b, the video processing unit 15 contains a video enhancement unit 153 and an enlargement/reduction unit 155. The video enhancement unit 153 processes the video signal to improve the quality of the image, such as gray scale and brightness enhancement, white balance and white tone enhancement, high frequency peaking, edge enhancement, color transition improvement, and skin tone enhancement, etc. The video enhancement unit 153 also contains a color matrix unit 151 for color saturation and hue processing, etc. Then the enlargement/reduction unit 155 adjusts the signal according to analysis of video signal resolution and the screen resolution. Finally, the screen control unit 160 controls the adjusted signal for display on the screen.

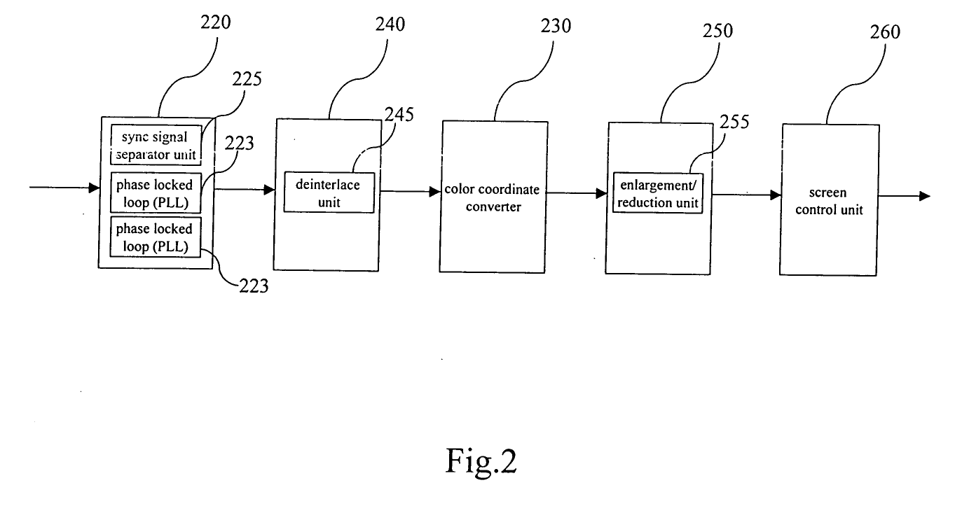

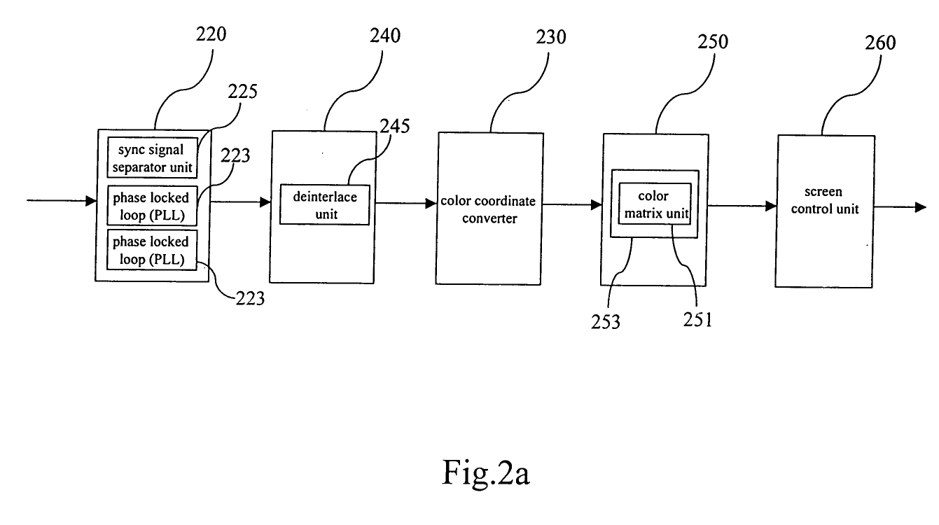

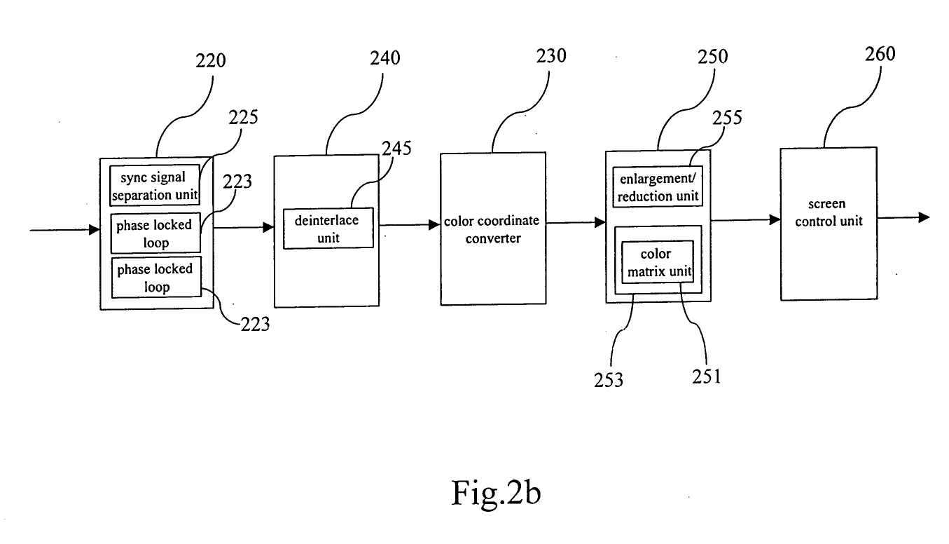

FIG. 2 shows another embodiment of the present invention. An analog chroma difference signal is inputted to single chip analog analog-to-digital converter (ADC) unitg 220 to convert into digital color difference format. The ADC unit 220 includes a sync signal separation unit 225 to segregate out the luminance signal Y, and the horizontal and vertical sync signals. In addition, the ADC unit 220 also include two phase locked loops 223 utilizing the segregated horizontal sync signal and the vertical sync signal for producing a source sequence and frame sequence timing signals for application to different units in the system.

The digital color difference format is followed by a format detecting unit 240 to determine the display format, including resolution and scanning pattern, such a 480i/p, 576p, 720p and 1080i/p, etc. If the scanning pattern is determined to be interlacing, the detecting unit 240 deletes the interlacing sequence and changes the sequence to be progressive. Basically, the output from the detecting unit 240 is always of progressive sequence. Then the chrmaticity coordinates unit 230 converts the digital color video signal into digital tri-color primary color (RGB) format video signals.

The video signal from the chromaticity coordinates unit 230 is processed in a video processor unit 250. The video processing unit 250 contains an enlargement/reduction unit 255, which adjusts the video signal according to signal resolution and display screen resolution. Finally, the output from the enlargement/reduction unit 255 is transmitted through a screen control unit 260 for display on a liquid crystal screen.

One version of the second embodiment is shown in FIG. 2a. The video signal processing unit 250 has a video enhancement unit 253 to process the image for improvement the quality of the picture, including the black and white stretch, white balance and white tone enhancement, high frequency peaking, edge enhancement, color transition improvement, and skin tone enhancement, etc. Finally, the signal is transmitted through a screen control unit 260 to display an image on the liquid crystal screen.

FIG. 2b shows another version of the second embodiment, the video signal processor 250 contains a signal enhancement unit 253 and an enlargement/reduction unit 255. The video signal enhancement unit proceeds to improve the quality of the picture, including the black and white stretch, white balance and white tone enhancement, high frequency peaking, edge enhancement, color transition improvement and skin tone enhancement, etc. The video enhancement unit further contains a matrix arrangement unit 251 to process the color saturation and hue, etc. Then the enlargement/reduction unit 255 processes the enhanced video signal according to of resolution of the video signal and the screen.. Finally, the processed signal is transmitted through a screen control unit for display on a liquid crystal screen.

While the preferred embodiments of this invention has been described, the rights of the invention are not limited to these embodiments. It will be obvious to those skilled in the art that various modifications may be made to those embodiments. Such modifications are all within the scope of the present invention.

1. A video display system, comprising:
an analog-to-digital converter unit to convert an analog color difference signal into a digital color difference signal, wherein said analog color difference signal includes a luminance signal;
a color coordinate converter unit to convert said digital color difference signal to a digital three-primary color signal, wherein said digital three-primary color signal contains information on resolution and scanning format;
a format detecting unit for inputting said digital three-primary color signal and producing a progressive format three-primary color signal; and
a video processing unit for processing said progressive format three-primary color signal to produce a video display signal on a screen.

2. The video display system as described in claim I, wherein said analog-to-digital converter unit includes a sync separation unit, which derives a horizontal sync signal and a vertical sync signal based on the amplitude of said analog color difference signal.

3. The video display system as described in claim 2, wherein the sync separation unit contains a first phase-locked loop, which produces a source timing clock for said system.

4. The video display system as described in claim 2, wherein said sync separation unit comprises a second phase-locked loop to produce a panel timing clock from said horizontal sync signal.

5. The video display system as described in claim 1, wherein said format detecting unit comprises:
a determining unit to determine whether the scanning format is interlacing; and
a deinterlace unit to deinterlace any interlacing signals into progressive signals.

6. The video display system as described in claim 5, wherein said format determining unit determines the resolution and scanning format selected from the group consisting of 480i/p, 576p, 720p and 1080i/p.

7. The video display system as described in claim 1, wherein said video signal processing unit further comprises a video enhancement unit to enhance the picture quality of the video display signal.

8. The video display system as described in claim 1, wherein said video signal processing unit further contains a enlargement/reduction scaler unit to adjust said video display signal according to the resolution of said video display signal and resolution of the screen.

9. The video display system as described in claim 1, wherein said video processing unit further comprises a video enhancement unit to enhance the three-primary color signal, to enable enlargement/reduction of said three primary color digital signal resolution and display screen resolution, and to adjust the video display signal.

10. The video display system as described in claim 1, further comprising a screen control unit to receive said video display signal for display on the screen.

11. A video display system, comprising:
an analog-to-digital converter unit to convert an analog color difference signal to a digital color difference signal, wherein said analog color difference signal contains a luminance signal and the digital color difference signal contains information on resolution and scanning format;
a format detecting unit to receive said digital color difference signal and to produce a progressive scanning format based on said scanning format;
a chromaticity coordinate unit to convert said digital color difference signal to a digital three-primary color signal; and
a video signal processing unit to process said three-primary color for producing a video display signal.

12. The video display system as described in claim 11, wherein said analog-to-digital converter unit contain a sync signal separation unit, which produces a horizontal sync signal and vertical sync signal based on the amplitude of said analog color difference signal.

13. The video display system as described in claim 12, wherein said sync signal separation unit contains a first phase locked loop to produce a source timing signal based on said horizontal sync signal.

14. The video display system as described in claim 2, wherein said sync signal separation unit contain a second phase-locked loop to produce a panel timing signal based on said horizontal sync signal.

15. The video display system as described in claim 1, wherein said format detecting unit comprises:
a detection unit to determine whether said digital color difference signal is of interlacing format; and
a deinterlace unit to change the interlacing format to progressive format if the digital color difference signal is of interlacing format.

16. The video display system as described in claim 15, wherein said detection unit selects from the group consisting of: 480i/p, 576p, 720p and 1080i/p.

17. The video display system as described in claim 11, wherein said video processing unit further contains a video enhancement unit to enhance the video display signal in a progressive scanning format.

18. The video display system as described in claim 11, wherein video processing unit further contains an enlargement/reduction unit to adjust said digital three-primary color signals based on said video display signal resolution and the resolution of the screen for producing said video display signal.

19. The video display system as described in claim 11, wherein said video processing unit further contains a video enhancement unit to enhance said digital three-primary color signal and enhance enlargement/reduction manipulation based on said video display signal resolution and resolution of the screen for producing said video display signal.

20. The video display system as described in claim 11, further comprising screen control unit to accept said video display signal for display on a screen.
